(19) United States
(12) Patent Application Publication
(10) Pub. No.: US 2009/0211556 A1
(43) Pub. Date: Aug. 27, 2009

(54) System for maintaining a pump inlet pressure

(75) Inventor: Paul John Smith, Peterborough (GB)

Correspondence Address: CATERPILLAR/FINNEGAN, HENDERSON, L.L.P., 901 New York Avenue, NW, WASHINGTON, DC, 20001-4413, US

(73) Assignee: PERKINS ENGINES COMPANY LIMITED

(21) Appl. No.: 12/071,687

(22) Filed: Feb. 25, 2008

(51) Int. Cl. F02M 69/46

(52) U.S. Cl. 123/457; 123/456

(57) ABSTRACT

A fuel system is disclosed. The fuel system has a first pump configured to provide fuel at a first pressure. The fuel system also has a control valve disposed downstream of the first pump, the control valve being configured to selectively direct the fuel at the first pressure to a treatment device and a regulator valve. The fuel system further has a fuel filter disposed downstream of the regulator valve. The fuel system also has a second pump disposed downstream of the fuel filter. The fuel system further has a relief valve disposed downstream of the fuel filter and upstream of the second pump, the relief valve being configured to maintain fuel upstream of the second pump at a second pressure that is different from the first pressure.

### TECHNICAL FIELD

The present disclosure is directed to a system for maintaining inlet pressure and, more particularly, to a system for maintaining a pump inlet pressure.

### BACKGROUND

Diesel engines typically rely on compression ignition, where fuel is injected into a combustion chamber after air has been compressed to cause substantially immediate combustion without requiring a sparkplug. Compression ignition diesel engines typically include a common rail fuel injection system, directing pressurized fuel to individual fuel injectors for injection into the combustion chamber. Prior to entering the common rail, fuel is typically pumped through a primary filter and a secondary filter by a feed pump located between the filters. A high-pressure pump is typically located downstream of the secondary filter.

Additionally, an exhaust system associated with a compression ignition diesel engine may include a diesel particulate trap for collecting particulates in the exhaust gas. These traps are typically regenerated by injecting fuel upstream of the particulate trap, burning the injected fuel, and raising the temperature of the exhaust gas. Fuel is typically injected from a fuel pump of the diesel engine directly into the exhaust system to achieve the required regeneration temperatures. It may be difficult to regulate the inlet pressure of the high-pressure pump in systems that are configured to inject fuel to both the common rail and the exhaust system. Accordingly, high-pressure pumps used in these types of systems are typically insensitive to inlet pressure, thus limiting the types of high-pressure pumps that may be used with a single low-pressure pump arrangement. If a high-pressure pump that is sensitive to inlet pressure must be used in a common rail system, two feed pumps are typically required because of the difficulty in regulating the inlet pressure.

One attempt at using a single low-pressure pump to provide fuel to both the common rail and the exhaust system is described in U.S. Patent Application Publication 2007/0227126 (the '126 publication) by Wang et al. The '126 publication discloses a fuel pumping arrangement including a single low-pressure pump supplying both a high-pressure pump and a regeneration device. The '126 publication also discloses a valve element for selectively directing fuel flow from the low-pressure pump to the high-pressure pump and the regeneration device. The '126 publication further discloses a bypass circuit having a regulator valve for affecting a pressure of the fuel flowing to the high-pressure pump.

Although the fuel system of the '126 publication may provide a method for supplying pressurized fuel from a single low-pressure pump to a high-pressure pump and an exhaust treatment device, it may not also control the inlet pressure of the high-pressure pump. Also, in the fuel system of the '126 publication, the secondary filter upstream of the high-pressure pump may become partially blocked and may vary the inlet pressure of the high-pressure pump. Therefore, a high-pressure pump that is sensitive to variations in inlet pressure may not be suitable for use within the fuel system described by the '126 publication.

The present disclosure is directed to overcoming one or more of the shortcomings associated with prior art devices.

### SUMMARY OF THE DISCLOSURE

In accordance with one aspect, the present disclosure is directed toward a fuel system. The fuel system includes a first pump configured to provide fuel at a first pressure. The fuel system also includes a control valve disposed downstream of the first pump. The control valve is configured to selectively direct the fuel at the first pressure to a treatment device and a regulator valve. The fuel system further includes a fuel filter disposed downstream of the regulator valve and a second pump disposed downstream of the fuel filter. The fuel system further includes a relief valve disposed downstream of the fuel filter and upstream of the second pump. The relief valve is configured to maintain fuel upstream of the second pump at a second pressure that is different from the first pressure.

According to another aspect, the present disclosure is directed toward a method for directing fuel flow. The method includes pressurizing fuel at a first pressure and selectively directing the pressurized fuel at the first pressure toward a treatment device and toward a pump. The method also includes injecting the fuel into the treatment device to selectively affect regeneration and filtering the fuel upstream of the pump. The method further includes selectively pressurizing fuel at a second pressure, downstream of the filtering and upstream of the pump.

### BRIEF DESCRIPTION OF THE DRAWINGS

FIG. 1 is a schematic illustration of an exemplary disclosed fuel system.

### DETAILED DESCRIPTION

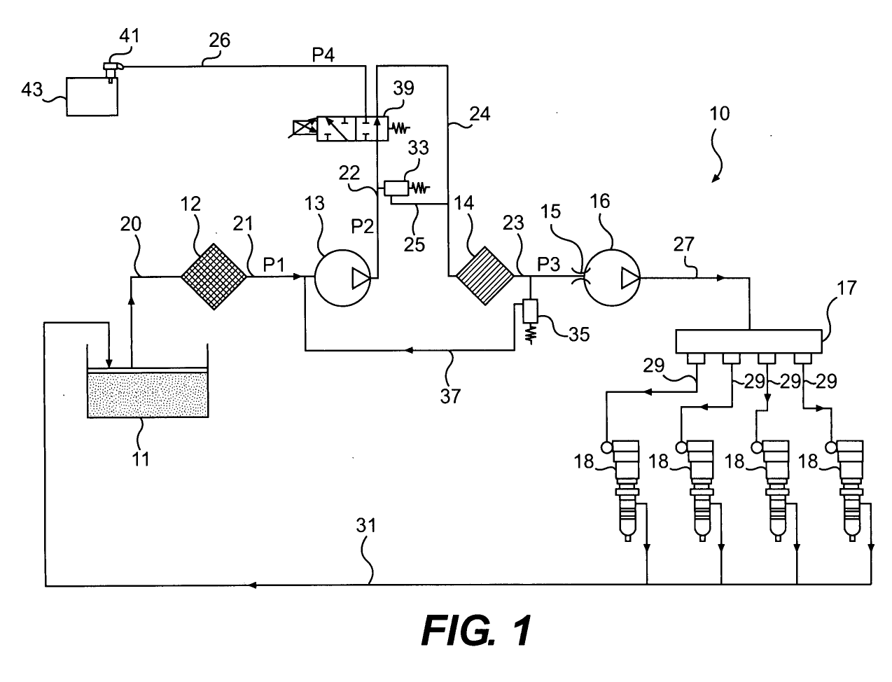

FIG. 1 illustrates an exemplary fuel system 10. Fuel system 10 may be a common rail fuel injection system and may include a fuel reservoir 11, fluidly connected via passage 20 to a filter 12. Fuel system 10 may also include a pump 13 fluidly connected downstream of filter 12 via passage 21 and fluidly connected upstream of a filter 14 via passage 22 and passage 24. Fuel system 10 may additionally include a pump 16 fluidly connected downstream of filter 14 via passage 23. Fuel system 10 may also include a common rail 17 fluidly connected downstream of pump 16 via passage 27 and fluidly connected upstream of a plurality of injectors 18 via a plurality of passages 29. Injectors 18 may inject fuel into an engine (not shown) and may be fluidly connected to reservoir 11 via a leak return passage 31. Fuel system 10 may also include a control valve 39 disposed within passage 22 and configured to selectively connect pump 13 to an injector 41 and a treatment device 43, via passage 22 and passage 26, and to pump 16 via passage 23 and passage 24. Fuel system 10 may further include a regulator valve 33, located within passage 25 and connecting passage 22 to passage 24, and may include a relief valve 35, located within passage 37 and connecting passage 23 to passage 21.

Filter 12 and filter 14 may be any suitable type of fuel filter known in the art such as, for example, a stainless steel or a plastic fuel filter. Filter 12 and filter 14 may screen out rust, dirt, or other particles from the fuel. These particles may enter fuel system 10, for example, when rust or paint chips are knocked into a fuel inlet during fueling. Filter 12 may be a primary filter configured to remove relatively larger particles than filter 14, which may be a secondary filter configured to remove relatively smaller particles. It is contemplated that fuel may be filtered in a two-step process, in which larger particles may be filtered via filter 12 and smaller particles may be filtered via filter 14, prior to flowing to pump 16.

Pump 13 may be a swash plate pump, having a rotating cylinder (not shown) containing pistons (not shown). The swash plate angle may be varied, with the amount of fuel transferred increasing as the angle of the swash plate increases. It is contemplated that pump 13 may be a feed pump to direct fuel from reservoir 11 toward pump 16, via filter 12 and filter 14, and toward treatment device 43, via passage 22 and passage 26. It is contemplated that pump 13 may be configured to supply fuel at two pressures. Pump 13 may be configured to supply fuel at a first pressure to pump 16, via passage 22, passage 24, and passage 23, and at a second pressure to injector 41 and treatment device 43, via passage 22 and passage 26. It is contemplated that the pressure of fuel supplied to injector 41 and treatment device 43 may be significantly higher than the pressure of fuel supplied to pump 16. It is further contemplated that the pressure of fuel supplied to injector 41 and treatment device 43 may be large enough to open regulator valve 33, allowing pump 13 to simultaneously feed treatment device 43 and pump 16, as will be explained in more detail below. It is also contemplated that pump 13 may be a gear pump or a vane pump, and may be driven by the engine.

Pump 16 may be any type of high-pressure pump known in the art that is suitable for common rail fuel injection. Pump 16 may be a variable orifice pump or an inlet-metered common rail fuel pump. An inlet of pump 16 may include a variable orifice 15, which may be associated with an electronic controller (not shown) for controlling dimensions of variable orifice 15. Variable orifice 15 may be sensitive to inlet pressure changes, requiring a substantially constant pressure to be maintained at the inlet of pump 16. Pump 16 may serve to maintain fuel stored within a reservoir (not shown) of common rail 17 at a relatively high-pressure. It is contemplated that pump 16 may provide pressurized fuel to common rail 17 for injection into the engine. It is also contemplated that pump 16 may be any suitable engine driven pump known in the art, including a pump that is insensitive to inlet pressure.

Common rail 17 may be an intake manifold configured to distribute the flow of pressurized fluid from pump 16 and to distribute fuel to injectors 18 via passages 29. Common rail 17 and injectors 18 may be associated with a controller (not shown) that may control an actuation timing, pressure, and duration of fuel injectors 18. By injecting pressurized fuel at optimal times during engine operation, for example at the end of a compression stroke of the engine, common rail 17 and injectors 18 may provide improved fuel atomization and thereby improved engine operation.

Treatment device 43 may include any suitable filtration media, absorber, reducer, and/or catalytic converter known in the art for reducing the emissions from an engine. Soot carried by exhaust from engine combustion may collect within treatment device 43 and require periodic regeneration. Regeneration of the filtration media may include combustion of the trapped soot. It is contemplated that injector 41 may be operable to inject an amount of pressurized fuel, received from pump 13 via control valve 39, into exhaust treatment device 43. Because exhaust in treatment device 43 may be above the combustion temperature of fuel injected via injector 41, injected fuel may ignite and combust the trapped soot.

Regulator valve 33 may be located within passage 25 and may control the amount of fuel passing through passage 25. Regulator valve 33 may include a spool element seated against a spring element within a housing (not shown). The spool element may be movable from a first position substantially blocking flow to a second position permitting flow through passage 25. When the pressure upstream of regulator valve 33 reaches a predetermined pressure, the pressure of the fluid may overcome the spring bias and move the spool from the first position to the second position. For example, in an exemplary embodiment, the predetermined pressure to overcome the spring bias may be 220 psi. Regulator valve 33 may include restricting orifices of differing sizes at an inlet and an outlet thereof configured to reduce the pressure of the fuel passing through regulator valve 33. Therefore, regulator valve 33 may release fuel into passage 25 at a lower pressure than the fuel in passage 22. For example, in an exemplary embodiment, a pressure of fuel within passage 22 may be approximately 300 psi, the spring bias of regulator valve 33 may be overcome because 300 psi exceeds the predetermined pressure of 220 psi, and regulator valve 33 may open. Regulator valve 33 may establish a pressure drop of 80 psi, releasing fuel at a pressure of 220 psi into passage 25 and filter 14. It is contemplated that regulator valve 33 may create a bypass circuit, around control valve 39, for fuel pumped by pump 13 to flow to pump 16 when the pressure upstream of regulator valve 33 exceeds the predetermined pressure (e.g., when pump 13 is pumping to injector 41 and treatment device 43).

Control valve 39 may operate to selectively direct fuel pumped by pump 13 to treatment device 43 and/or pump 16. Control valve 39 may be a spring-centered shuttle valve, including an electronically controlled valve element that is movable against a spring bias in response to a command. Control valve 39 may be movable from a first position (shown in FIG. 1) at which pressurized fuel from pump 13 may be directed to pump 16 and common rail 17. Control valve 39 may also be movable to a second position, at which fuel may be directed from pump 13 to injector 41 and treatment device 43. It is contemplated that by selectively moving between the first and second position, control valve 39 may control the direction of fuel flow within fuel system 10. It is contemplated that control valve 39 may be connected to a controller (not shown) via a communication line to receive electronic signals indicative of which of the first and second positions is desired.

Relief valve 35 may be located within passage 37 and may control a pressure upstream of variable orifice 15 of pump 16. Relief valve 35 may include a plunger seated on a spring, located within a housing (not shown). The plunger may be movable from a first position substantially blocking flow through passage 37 to a second position permitting flow through passage 37. Fuel upstream of pump 16 may exert a pressure on an upstream portion of the plunger at a certain threshold pressure, overcoming the spring bias and affecting the plunger to move from the first position to the second position. This threshold pressure may, for example, correspond to a desired pressure at variable orifice 15 for optimal operation of pump 16. Fuel relieved from passage 23 may be directed, via passage 37, to an inlet of pump 13, thereby maintaining the desired pressure upstream of pump 16. For example, in an exemplary embodiment, a desired pressure at the inlet of pump 16 may be 70 psi. When the pressure of fuel at the inlet of pump 16 exceeds 70 psi, relief valve 35 may open, allowing fuel to be relieved via passage 37 and thereby maintaining a pressure of 70 psi upstream of pump 16. It is contemplated that relief valve 35 may maintain a substantially constant pressure at the inlet of pump 16, regardless of whether control valve 39 is in the first or second position.

### INDUSTRIAL APPLICABILITY

The disclosed fuel system 10 may maintain a constant inlet pressure for a high-pressure pump, while using a single low-pressure pump to supply both the high-pressure pump and fuel for regeneration. Fuel system 10 may also maintain a constant inlet pressure at the high-pressure pump, regardless of any pressure changes caused by upstream filters. Because fuel system 10 may maintain a constant inlet pressure, pump 16 may be configured as a pump sensitive to inlet pressure and fuel system 10 may include a single low-pressure pump, e.g., pump 13.

As shown in FIG. 1, fuel system 10 may operate when control valve 39 is in the first position, allowing pump 13 to supply fuel at a first pressure to pump 16 and substantially blocking fuel to injector 41 and treatment device 43. Pump 13 may pump fuel from reservoir 11 to pump 16 via passages 20, 21, 22, 24, and 23, filter 12, and filter 14. Pump 13 may operate so that fuel in passage 21 may be at a pressure P1 and fuel in passage 22 may be at a pressure P2. When control valve 39 is in the first position (shown in FIG. 1), fuel may flow to pump 16, via passage 22 and passage 24. Pressure P2 may be less than the predetermined pressure necessary to overcome the spring bias of regulator valve 33, and regulator valve 33 may remain closed, substantially blocking flow through passage 25. Filter 14 may affect the flow of fuel, and thereby affect a pressure P3. Relief valve 35 may relieve fuel via passage 37 to the inlet of pump 13, thereby maintaining pressure P3 at a substantially constant pressure that may be optimal for the operation of pump 16.

Fuel system 10 may also operate when control valve 39 is in the second position, allowing pump 13 to supply fuel at a second pressure (significantly larger than the pressure supplied to pump 16) to treatment device 43. Pump 13 may pump fuel from reservoir 11 to treatment device 43 via passage 22 and passage 26, where a pressure P4 of the fuel in passage 26 may be substantially equal to pressure P2. Pressure P2 may exceed the predetermined pressure required to overcome the spring bias of regulator valve 33, affecting regulator valve 33 to open. When regulator valve 33 is open, pump 13 may pump fuel simultaneously to pump 16 and treatment device 43. Regulator valve 33 may also cause a pressure drop in fuel. Fuel may flow from regulator valve 33 to filter 14, via passage 25 and passage 24. Similar to above, filter 14 may affect fuel flow and thereby affect pressure P3. Regardless of the effect of filter 14 on pressure P3, relief valve 35 may operate to relieve fuel via passage 37 and maintain pressure P3 at a substantially constant pressure, regardless of the position of control valve 39. Fuel system 10 may also operate to maintain pressure P4 for optimal injection into treatment device 43, which may be significantly larger than pressure P3 for optimal operation of pump 16.

In an exemplary embodiment, for example, pump 13 may supply pressurized fuel to passage 22 at substantially 300 psi and passage 26 at substantially 300 psi. In the exemplary embodiment, regulator valve 33 may be open when pressure within passage 22 is greater than 220 psi and may cause a pressure drop, releasing fuel downstream into passage 25 at 220 psi via restricting orifices associated with regulator valve 33. In the exemplary embodiment, relief valve 35 may maintain pressure P3=70 psi, which may be significantly smaller than P4=300 psi.

Fuel system 10 may maintain a substantially constant pressure P3 upstream of variable orifice 15 of pump 16, while pump 13 is configured to supply pressurized fuel to both pump 16 and treatment device 43. Fuel system 10 may maintain a constant inlet pressure P3, regardless of the effect of filter 14. Because fuel system 10 may use pump 13 for both regeneration and feeding pump 16, while still maintaining a constant pressure P3, pump 16 may be a pump that is sensitive to inlet pressure. Therefore, fuel system 10 may allow the use of a suitable high-pressure pump, without being restricted to using only high-pressure pumps that are insensitive to inlet pressure.

It will be apparent to those skilled in the art that various modifications and variations can be made to the disclosed system. Other embodiments will be apparent to those skilled in the art from consideration of the specification and practice of the disclosed method and apparatus. It is intended that the specification and examples be considered as exemplary only, with a true scope being indicated by the following claims.

1. A fuel system, comprising:
a first pump configured to provide fuel at a first pressure;
a control valve disposed downstream of the first pump, wherein the control valve is configured to selectively direct the fuel at the first pressure to a treatment device and a regulator valve;
a fuel filter disposed downstream of the regulator valve;
a second pump disposed downstream of the fuel filter; and
a relief valve disposed downstream of the fuel filter and upstream of the second pump, the relief valve configured to maintain fuel upstream of the second pump at a second pressure that is different from the first pressure.

2. The fuel system of claim 1, wherein the first pump is configured to supply fuel at at least two different pressures.

3. The fuel system of claim 1, wherein the relief valve maintains the second pressure by selectively directing fuel from an inlet of the second pump to an inlet of the first pump.

4. The fuel system of claim 1, wherein the second pump is a variable orifice pump.

5. The fuel system of claim 1, wherein the control valve is a spring-centered shuttle valve.

6. The fuel system of claim 1, wherein the regulator valve includes a spring bias configured to open the regulator valve when the first pressure exceeds a predetermined pressure.

7. The fuel system of claim 1, wherein the first pressure is larger than the second pressure.

8. The fuel system of claim 1, wherein the fuel system is a common rail fuel injection system.

9. A method for directing fuel flow, comprising:
pressurizing fuel at a first pressure;
selectively directing the pressurized fuel at the first pressure toward a treatment device and toward a pump;
injecting the fuel into the treatment device to selectively affect regeneration;
filtering the fuel upstream of the pump; and
selectively pressurizing fuel at a second pressure, downstream of the filtering and upstream of the pump.

10. The method of claim 9, wherein the first pressure is larger than the second pressure.

11. The method of claim 9, wherein the second pressure is reduced by relieving fuel to a location upstream of the pressurizing of the fuel at the first pressure.

12. The method of claim 9, wherein selectively directing includes a first operating mode wherein fuel is directed to only the pump and a second operating mode wherein fuel is directed to the pump and the treatment device.

13. The method of claim 12, wherein selectively directing the fuel to the pump and to the treatment device occurs when the first pressure exceeds a predetermined pressure.

14. The method of claim 9, further including directing fuel flow from the pump to a common rail.

15. A fuel injection system, comprising:
a reservoir;
a first filter fluidly connected downstream of the reservoir;
a first pump configured to provide fuel at a first pressure;
a control valve located downstream of the first pump, wherein the control valve is configured to selectively direct fuel toward a treatment device and a regulator valve;
a second filter located downstream of the regulator valve;
a second pump located downstream of the second filter; and
a relief valve located downstream of the second filter and upstream of the second pump, the relief valve configured to maintain a second pressure at an inlet of the second pump that is less than the first pressure.

16. The fuel injection system of claim 15, wherein the second pump is a variable orifice high-pressure pump.

17. The fuel injection system of claim 15, wherein the control valve is a spring-centered shuttle valve.

18. The fuel injection system of claim 15, wherein the treatment device includes an injector for injecting fuel into the treatment device to selectively affect regeneration.

19. The fuel injection system of claim 15, wherein the first pressure is larger than the second pressure.

20. The fuel injection system of claim 15, further including a common rail for fuel injection into an engine, wherein the common rail is located downstream of the second pump.
